(19) United States
(12) Patent Application Publication
(10) Pub. No.: US 2019/0047030 A1
(43) Pub. Date: Feb. 14, 2019

(54) METHOD OF FOLDING METAL BLANK MADE OF HIGH-STRENGHT MATERIAL WITHOUT CRACKS

(71) Applicant: KONINKLIJKE PHILIPS N.V., EINDHOVEN (NL)

(72) Inventors: JAN WYTZE VAN DER WEIT, EINDHOVEN (NL); GERRIT KLASEBOER, EINDHOVEN (NL); HUBERT SJOERD BLAAUW, EINDHOVEN (NL); JAN AUKE HOVIUS, EINDHOVEN (NL); CHRISTO POSTMUS, EINDHOVEN (NL); MARCO VAN DER MOLEN, EINDHOVEN (NL); DOUWE HOEKSTRA, EINDHOVEN (NL)

(21) Appl. No.: 16/078,668

(22) PCT Filed: Feb. 10, 2017
(86) PCT No.: PCT/EP2017/052943

§ 371 Date: Aug. 22, 2018

(30) Foreign Application Priority Data
Feb. 23, 2016 (EP) 16157011.4

(51) Int. Cl. B21D 11/08; B21D 53/64; B26B 19/14; B26B 19/42

(52) U.S. Cl. CPC B21D 11/08; B26B 19/42; B26B 19/141; B21D 53/64

(57) ABSTRACT

A method of manufacturing a component from a high-strength blank metal strip or sheet (MS) having a tensile strength of at least 850 MPa. The method comprises reducing the thickness (T) of the strip or sheet (MS) in a folding section (FS) so that a shaped section (SS) having a predetermined shape is obtained in at least a part of the folding section (FS). The strip or sheet (MS) is then folded along the shaped section (SS), so that a surface of a first section (1S) becomes arranged adjacent and parallel to a surface a the second section (2S) of the metal strip (MS). Finally, the first and second sections (1S,2S) are joined, so that the strip or sheet (MS) remains folded. With this method, it is possible to use high-strength steel, e.g. AISI 301 stainless steel, and still fold a thin strip or sheet (MS) without undesired cracks in the folding section. For example, the invention is applicable for manufacturing of plate-shaped hair-pulling elements (HPE) for a cutting unit (CU) of a shaving apparatus.

### FIELD OF THE INVENTION

The invention relates generally to a method of manufacturing of products made from a high-strength blank metal strip or sheet having a tensile strength of at least 850 MPa, such as metal products for shaving systems. Specifically, the invention relates to such a method comprising bending or folding a steel blank strip or sheet over a bending radius equal to or smaller than a thickness of the blank metal strip or sheet without causing undesirable cracks.

### BACKGROUND OF THE INVENTION

Some shaving systems contain a metal hair-pulling element for retracting hairs partially out of the skin before they are cut. This is known e.g. as a hair-retraction spider forming part of a rotary cutter in a rotary-type electric shaver. To improve the hair-retraction efficiency, the thickness of the end portion of the hair-pulling element is increased by double folding (flapping) the metal sheet material at the location of the end portion.

EP-B-1 212 176 describes a method of manufacturing a blade-shaped hair-pulling element for a cutting unit of a shaver, wherein the hair-pulling element is formed by bending the steel material to form a thickened end portion of the hair-pulling element.

This double bending or folding or flapping is a critical process step in the manufacturing of the hair-retraction spider, since the bending or folding is performed over a small radius, in particular a radius equal to or lower than the material thickness. Such bending or folding of the steel material can cause undesirable cracking of the steel material in the bending zone, thus at the tip of the hair-retraction spider.

For some steel types cracking does not occur. However, when using steel having a high strength during forming, e.g. AISI 301 steel, the cracking problem typically occurs. Thus, this problem prevents utilizing AISI 301 steel to reduce material costs in the manufacturing of hair-pulling elements for shavers.

### SUMMARY OF THE INVENTION

Following the above, the inventors of the present invention have appreciated that an improved method of manufacturing such a folded hair-pulling element of metal without cracking problems is of benefit, and have in consequence devised the present invention.

It would be advantageous to achieve a method of manufacturing a metal product which allows double folding of a metal sheet or strip with a bending radius equal to, or even smaller than, the thickness of the metal sheet or strip without cracking in the folding section. It would also be desirable if such a method is simple to perform, so as to allow low-cost metal products in a mass-production process. In general, the invention preferably seeks to mitigate, alleviate or eliminate one or more of the above mentioned disadvantages singly or in any combination. In particular, it may be seen as an object of the present invention to provide a method that solves the above mentioned problems, or other problems, of the prior art.

In a first aspect, the invention provides a method of manufacturing a component from a high-strength blank metal strip or sheet having a tensile strength of at least 850 MPa, the method comprising:
providing the blank metal strip or sheet having a thickness, a longitudinal extension and a width perpendicular thereto, the strip or sheet comprising a first section and a second section separated by a folding section which extends along the width of the strip or sheet,
folding the strip or sheet along the folding section with a bending radius equal to or smaller than the thickness so that a surface of the first section becomes arranged adjacent and parallel to a surface of the second section, and
joining the first and second sections so that the strip or sheet remains folded, wherein the method further comprises, before said folding of the strip or sheet, reducing the thickness of the strip or sheet in the folding section by use of a shaping tool so that a shaped section is obtained having a predetermined shape, seen in a cross-section perpendicular to the width, in at least a part of the folding section, and wherein said folding of the strip or sheet is along said shaped section.

This method of manufacturing a folded strip or sheet from a high-strength metal is advantageous, since the inventors have found that introducing the step of reducing the thickness of the strip or sheet, e.g. by performing a pre-flattening step, in the folding section can eliminate crack problems in the folding section even in cases where the bending or folding radius is lower than the thickness of the metal strip or sheet. E.g. this allows the use of AISI 301 stainless steel for manufacturing a hair-retraction element for a shaving system, comprising an end portion with an increased thickness obtained by folding the end portion of the hair-retraction element. By enabling the use of AISI 301 stainless steel, it is possible to save costs for the hair-retraction element as compared to the use of other steel types. The necessary steps of the method of the invention are simple to perform, and thus do not introduce any complicating factor in the manufacturing process. The step of reducing the material thickness in the folding section can be implemented as an additional first step in the manufacturing process, or it can be combined with a first pre-bending step of the strip or sheet. It is appreciated that the invention is applicable for manufacturing of a variety of other metal elements where a folding step to obtain a double thickness of the element is performed, especially relatively thin metal strip or sheet.

The inventors have found that the actual shape of the material thickness reduction and the size of the thickness reduction relative to the initial thickness have an influence on the end result. In this respect, a step-wise reduction of the thickness has proven to provide the best results. In other words, differently shaped shaping tools can be used to still achieve the advantageous reduction or elimination of cracks. However, tests have shown that the use of a shaping tool which results in a step-wise reduction of the thickness of the folding section provides the best results.

By “becomes arranged adjacent and parallel to” in the claims is meant that the surfaces of the first and second section contact each other, preferably over their full surface areas. The “blank strip or sheet” is to be provided before the actual manufacturing process. Preferably the blank strip or sheet at least has a plane portion. By “high-strength metal” in the claims is meant a metal having a tensile strength of more than about 850 MPa. By “joining the first and second sections” in the claims is basically meant any process step for maintaining the surfaces of the first and second sections of the strip or sheet arranged adjacent and parallel to each other and in contact with each other, preferably over their full surface areas, after performing the joining step, e.g. by sufficiently pressing the folded strip or sheet between two flat objects. Alternatively, the joining step may comprise joining by laser welding, resistance welding, or glueing. Specifically, the joining may be performed along side rims only. An effect of the joining is that it is hereby prevented that dirt or grease comes in between the two surfaces during use of the component. Such dirt or grease could otherwise, at least for some applications, lead to a separation of the two surfaces, which could impair the properties or even lead to fracture.

In the following, preferred embodiments or features of the first aspect will be described.

The step of reducing the thickness may be performed so as to result in a step-wise reduction of the thickness between the shaped section and both the first section and the second section, seen in the cross-section perpendicular to the width of the strip or sheet. Such a step-wise reduction may include two, three or more steps each having a different thickness reduction, and each of these steps may have a certain spatial extension, seen in the direction of the longitudinal extension of the strip or sheet. In other words, with this embodiment of the invention, the shaped section may have a staircase of different thickness reductions from the original material thickness down to the smallest thickness, seen in said cross-section. In the most preferred embodiment, there is only one thickness-reduction step. In this most preferred embodiment, the step of reducing the thickness may result in a rectangular reduction of the thickness of the shaped section, seen in said cross-section. In an alternative embodiment, the step of reducing the thickness may be performed so as to result in a curved reduction of the thickness of the shaped section, seen in said cross-section. Especially, a radius of curvature of the curved reduction of the thickness of the shaped section may be within the range such as from 0.05 mm to 1.0 mm. An advantage of such an embodiment may be a reduced risk of cracks starting at a corner of the shaped section due to the notch effect.

The ratio between a minimum thickness of the shaped section and a thickness of the blank strip or sheet may be between 0.1 and 0.95, such as between 0.1 and 0.6 or between 0.4 and 0.95, preferably between 0.5 and 0.7.

The thickness of the blank strip or sheet may be from 50 μm to 2 mm, such as from 50 μm to 100 μm, or from 100 μm to 500 μm, or from 200 μm to 1 mm, preferably from 70 μm to 90 μm. These thicknesses can be used for manufacturing a hair-retraction element for shavers.

The step of reducing the thickness may be performed by coining, e.g. by the use of a flattening tool with a predetermined shape. “Coining” is understood as a form of precision stamping in which a workpiece is subjected to a sufficiently high stress to induce plastic flow in the surface of the material. A beneficial feature is that, in some metals, the plastic flow reduces surface grain size and hardens the surface, while the material deeper in the workpiece retains its toughness and ductility.

Alternatively to coining, the step of reducing the thickness may be performed by machining, such as by milling or grinding. Alternatively, the step of reducing the thickness may be a combination of coining and machining, if preferred.

The metal strip or sheet may be made from a material selected from: cold rolled austenitic stainless steel, hardened martensitic stainless steel, cold rolled duplex stainless steel, precipitation hardened stainless steel, hardened carbon steel, maraging steel, and a copper or nickel-based alloy spring material. Especially, for some applications, it may be preferred that the metal strip or sheet is made from AISI 301 stainless steel.

In one embodiment, the component is a blade-shaped hair-pulling or hair-retraction element for a cutting unit of a shaving apparatus.

In a second aspect, the invention provides an internal cutting member for a cutting unit of a shaving apparatus, said internal cutting member having cutter elements which are each provided with a cutting edge, at least one of the cutter elements being provided with an associated blade-shaped hair-pulling element which is in a frontmost position, as seen in a driven direction of the internal cutting member, and which is movable relative to the associated cutter element from and towards the cutting edge of the associated cutter element, while the blade-shaped hair-pulling element is provided with a thickened end with an edge. In particular said thickened end is manufactured by means of the steps of reducing the thickness and the steps of folding and joining the first and second sections of the metal strip or sheet according to the method according to the invention.

Especially, the blade-shaped hair-pulling element of the internal cutting member is manufactured according to any one of the mentioned embodiments of the method according to the invention.

In a third aspect, the invention provides a cutting unit for a shaving apparatus comprising a blade-shaped hair-pulling element manufactured according to a method according to the invention, which cutting unit is provided with an external cutting member and an internal cutting member which can be driven with respect to the external cutting member, said internal cutting member having cutter elements which are each provided with a cutting edge, while said external cutting member is provided with a wall portion with hair-trapping openings which are each bounded by a counter cutting edge for cooperation with the cutting edges of the drivable internal cutting member, at least one of the cutter elements being provided with an associated blade-shaped hair-pulling element which is in a frontmost position, as seen in a driven direction of the internal cutting member, and which is movable relative to the associated cutter element during operation of the shaving apparatus from and towards the wall portion of the external cutting member, while the hair-pulling element is provided with a thickened end with an edge which, during operation of the shaving apparatus, comes into contact with a hair projecting through one of the hair-trapping openings and pulls this hair further through the hair-trapping opening before said hair is cut off by the cooperation of the cutting edge of the associated cutter element and the counter cutting edge of the hair-trapping opening, wherein the thickened end of said blade-shaped hair-pulling element is obtained by means of the steps of reducing the thickness and the steps of folding and joining the first and second sections of the metal strip or sheet. Especially, a plurality of such blade-shaped hair-pulling elements may be arranged along with respective cutting elements to form a rotary cutting unit.

In a fourth aspect, the invention provides a shaving apparatus provided with a cutting unit according to the third aspect of the invention, or provided with a plurality of such cutting units. Especially, the shaving apparatus comprises one or more cutting units according to the third aspect, wherein the one or more cutting units are driven by an electric motor, e.g. powered by a battery or by an AC electric power.

In general, it is appreciated that the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1a, 1b and 1c schematically show a method of manufacturing a component from a high-strength blank metal strip or sheet according to the present invention.

FIG. 2a illustrates the principle of a hair-pulling element for a shaving apparatus,

FIG. 2b illustrates an example of a combination of a hair-pulling element arranged along with a cutter element,

FIG. 2c illustrates an example of a rotary cutter unit with a plurality of combinations of hair-pulling and cutter elements,

FIG. 3 illustrates the tip end of a prior art hair-pulling element made of a rather elastic steel in a metallographic light microscopic cross-sectional view,

FIG. 4a illustrates, in the same view as FIG. 3, the tip end of a hair-pulling element made of AISI 301 stainless steel manufactured according to a prior art method, where a crack at the tip end is visible,

FIG. 4b illustrates, in the same view as FIGS. 3 and 4a, the tip end of a hair-pulling element made of AISI 301 stainless steel, but manufactured with a pre-flattening method according to the invention, where no significant cracks are seen,

FIG. 5a illustrates cross-sectional views of different examples of a one-step reduction of the thickness of a metal strip or sheet,

FIG. 5b illustrates cross-sectional views of different examples of curved reductions of the thickness of a metal strip or sheet,

FIG. 5c illustrates a pre-bent strip or sheet with a curved reduction of the thickness,

FIGS. 6a, 6b and 6c illustrate examples of various steps of manufacturing a metal product from a metal strip or sheet, including folding or bending, and finally joining, and

FIG. 7 illustrates steps of an embodiment of the manufacturing method.

### DETAILED DESCRIPTION OF THE EMBODIMENTS

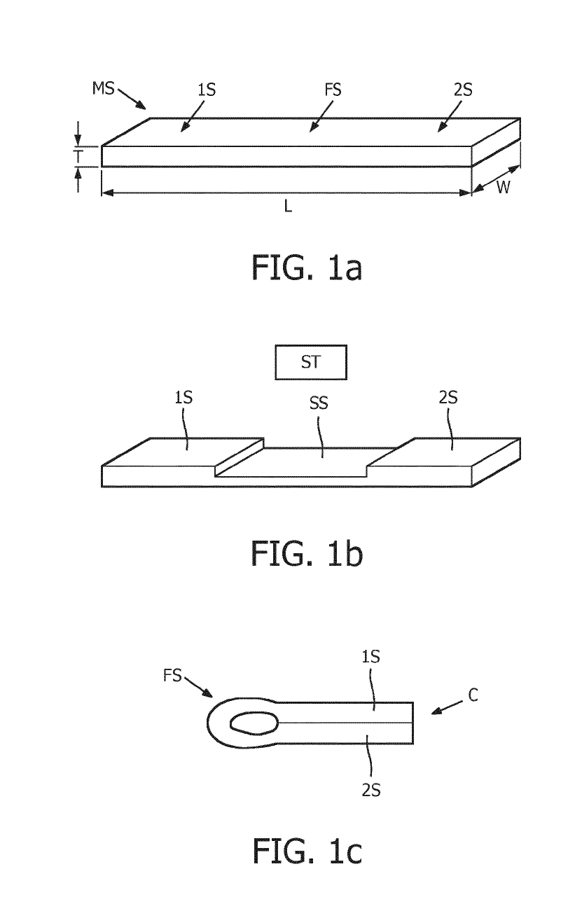

FIGS. 1a, 1b and 1c schematically show a method of manufacturing a component C from a high-strength blank metal strip or sheet MS according to the present invention. As shown in FIG. 1a, the method comprises providing the blank metal strip or sheet MS having a thickness T, a longitudinal extension L, and a width W perpendicular thereto. The strip or sheet MS comprises a first section 1S and a second section 2S separated by a folding section FS which extends along the width W of the strip or sheet MS. By use of a shaping tool ST, the thickness T of the strip or sheet MS is reduced in the folding section FS so that a shaped section SS is obtained. This is shown schematically in FIG. 1b. The shaping tool ST is shown schematically as a box, as different types of shaping tools can be used according to the invention. The shaped section SS has a predetermined shape, seen in a cross-section perpendicular to the width W, in at least a part of the folding section FS. In some embodiments of the invention, the extension of the shaped section SS is more or less identical to the extension of the folding section FS, whereas in other embodiments the extension of the shaped section SS and the folding section FS differ. It may e.g. be advantageous to make the shaped section SS larger than the folding section FS. The predetermined shape of the shaped section SS for a given component C to be manufactured may e.g. be determined experimentally or by computer simulations. The strip or sheet MS is subsequently folded along the shaped section SS so that a surface of the first section 1S becomes arranged adjacent and parallel to a surface of the second section 2S, as shown in FIG. 1c. Finally, the first and second sections 1S, 2S are joined (not shown in FIGS. 1a, 1b and 1c) so that the strip or sheet MS remains folded to form the component C. Such joining may be over the whole of the contacting surfaces of the first and second sections 1S, 2S, or it may be over a part of said contacting surfaces or along rims of said contacting surfaces only. The joining may e.g. be by welding or gluing. The end geometry of the folded section FS may be rounded as for the embodiment shown schematically in FIG. 1c. The strip or sheet MS may also be folded and pressed in process, resulting in a more pointed or sharp end geometry of the folded section FS.

In one application of the invention, the method of manufacturing a component from a high-strength metal strip or sheet according to the invention is advantageously used for providing a hair-pulling or hair-retraction element of a shaving apparatus with a thickened end portion having a double thickness. Especially, the thin metal element involved in the manufacturing of a hair-pulling element tends to have undesired cracks in the folding section, if a type of steel is used having a relatively high tensile strength. A steel such as AISI 301 or similar stainless steel can advantageously be used for a hair-pulling element due to its low cost and its high corrosion resistance. However, such a material has proven to result in cracks when processed, particularly when bent according to known manufacturing methods. This problem can be eliminated or at least significantly reduced by means of the manufacturing method according to the present invention, wherein the thickness T of the blank metal strip or sheet MS is locally reduced in the folding section FS.

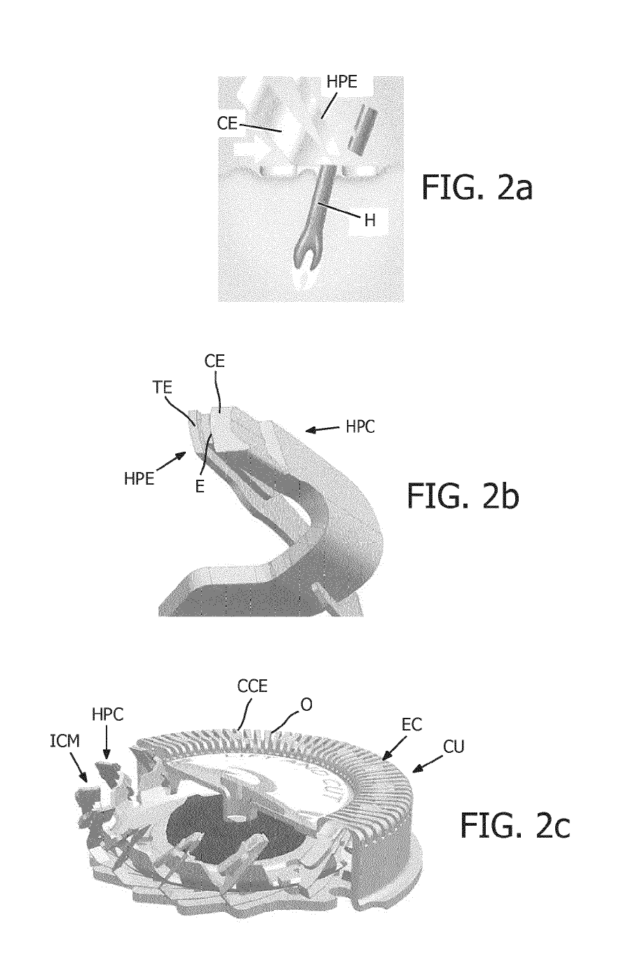

FIG. 2a shows the basic working principle of a hair-pulling element HPE which is arranged in relation to a cutter element CE such that, in the shaving process, the hair H is first lifted or partially pulled out of the skin by being hit, but not cut, by the edge of the hair-pulling element HPE. In the lifted condition of the hair H, the cutter element CE then cuts the hair H, thereby allowing the hair H to be cut at a lower point than when merely being cut without the co-operation of a hair-pulling element. The result is a more efficient and smooth shaving.

FIG. 2b shows an example of implementation of a combined unit HPC, comprising a blade-shaped hair-pulling element HPE with a thickened end TE and a cutter element CE. The thickened end TE of the hair-pulling element HPE can advantageously be provided by folding a metal sheet or strip, having a certain thickness, to end up with a hair-pulling element having the thickened end TE with a double thickness.

FIG. 2c shows a partial, cut-away view of an example of a rotary cutter unit CU for a shaving apparatus. A plurality of combined units HPC of hair-pulling and cutter elements are arranged in a circular configuration. One or more of such rotary cutter units can be arranged in a shaving apparatus, which further comprises a motor (not shown) to drive the rotary cutter unit CU into rotation. The cutting unit CU is provided with an external cutting member EC and an internal cutting member ICM which can be driven into rotation with respect to the external cutting member EC about a central axis (not shown) of the external cutting member EC. The internal cutting member ICM has cutter elements CE which are each provided with a cutting edge E, while said external cutting member EC is provided with a wall portion with hair-trapping openings O. The hair-trapping openings O are each bounded by a counter cutting edge CCE for cooperation with the cutting edges E of the drivable internal cutting member ICM. The cutter elements CE in the illustrated embodiment are each provided with an associated blade-shaped hair-pulling element HPE which is in a frontmost position, as seen in a driven direction of the internal cutting member ICM, and which is movable relative to the associated cutter element CE during operation of the shaving apparatus from and towards the wall portion of the external cutting member EC. The cutting of the hair H is as described in relation to FIG. 2a. During operation of the shaving apparatus, the hair-pulling element HPE comes into contact with a hair H projecting through one of the hair-trapping openings O and pulls this hair H further through the hair-trapping opening O before said hair H is cut off by the cooperation of the cutting edge E of the associated cutter element CE and the counter cutting edge CCE of the hair-trapping opening O.

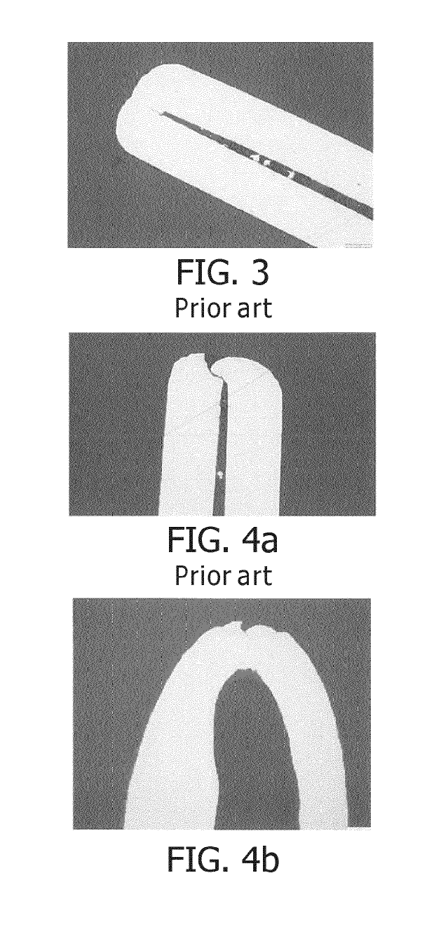

FIG. 3 shows a prior art example of the tip of a double folded hair-pulling element in a cross-sectional view, being a photo from a microscope. The double folding or flapping of the hair-pulling element is a critical process step. However, in this case a rather soft steel material has been used and, thus, the double-folded tip end is smooth without any cracks.

FIG. 4a shows an example of the tip of the same hair-pulling element manufactured by means of the same process as used to manufacture the hair-pulling element of FIG. 3, but in this case the material used is AISI 301 stainless steel, which has a relatively high tensile strength. Using this material, the folding or flapping process leads to undesired and unacceptable cracking at the bending area of the folding section, i.e. at the tip of the hair-pulling element, as seen on this photo.

FIG. 4b shows, in the same cross-sectional view as in FIG. 4a, a hair-pulling element manufactured from the AISI 301 stainless steel, but this element is manufactured in accordance with the invention, i.e. including the step of reducing the thickness of the blank metal strip or sheet in at least a part of the folding section, e.g. by applying a coining process prior to the folding step. As shown, with this additional step of reducing the thickness, the folded hair-pulling element is free from cracks in spite of the high tensile strength of the steel used, thus allowing this material to be used for manufacturing of the hair-pulling element with the same material thicknesses as used for hair-pulling elements made from softer steel materials.

Performing a proper folding or bending step in high-strength steels without cracks requires an enhanced material flow. The shape of the shaping tool and the depth of the flattening, i.e. the amount of thickness reduction, both have an influence on this. During testing it was discovered that a flat profile, i.e. a step-wise reduction of the thickness, provides the best results. A step-wise flattening with a reduction of the thickness down to 30-60% of the thickness of the blank strip or sheet has been found to provide good results for metal strips or sheets with an initial thickness in the range of 20-200 μm. In a special embodiment, where AISI 301 stainless steel is used for a hair-pulling element, an initial thickness is 70 μm to 90 μm, most preferably 80 μm or around 80 μm, and a step-wise reduction of the thickness in the folding section down to a thickness of from 40 μm to 50 μm is applied, e.g. by coining, prior to the folding and joining steps.

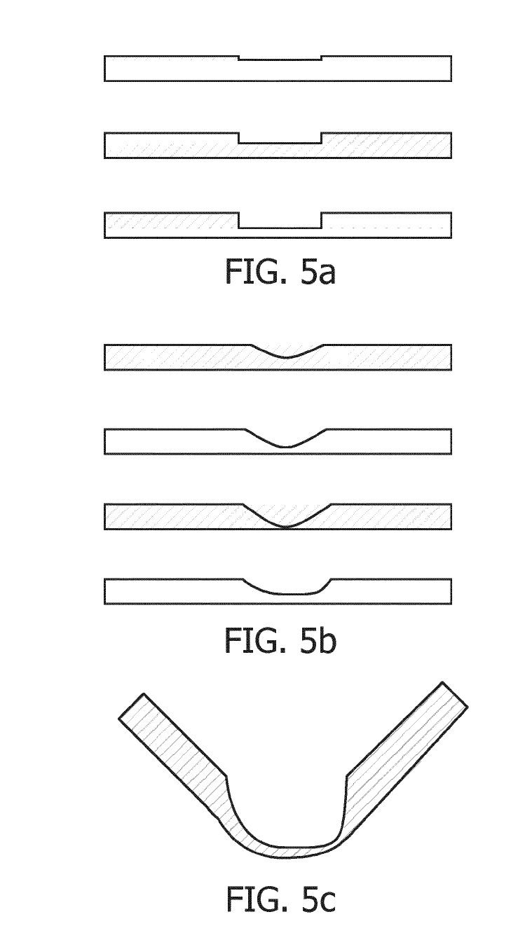

FIG. 5a shows, in a cross-section of the metal strip or sheet MS (as shown in FIGS. 1a and 1b) taken along a longitudinal extension L of the strip or sheet and perpendicularly to a width W of the strip or sheet, examples of the preferred step-wise reduction of the thickness in a single step, which is preferably also performed by a single coining step. The illustration shows step-wise reductions of the thickness with various ratios between the minimum thickness of the shaped section and the thickness of the original blank strip or sheet, such as 80-90% (upper figure), such as 40-60% (middle figure), and such as 20-30% (lower figure). It is to be understood that the step-wise reduction of the thickness can be achieved also in two or more process steps, if preferred. In these examples, the step of reducing the thickness results in a rectangular reduction of the thickness of the shaped section, seen in said cross-section

FIG. 5b shows, in a cross-section of the metal strip or sheet MS (as shown in FIGS. 1a and 1b) taken along a longitudinal extension L of the strip or sheet and perpendicularly to a width W of the strip or sheet, examples of reductions of the thickness comprising curved reductions of the thickness of the shaped section, seen in said cross-section. Like the examples in FIG. 5a, the examples in FIG. 5b show various ratios between the minimum thickness of the shaped section and the thickness of the original blank strip or sheet.

FIG. 5c shows an example of a pre-bent or pre-folded metal strip or sheet MS (as shown in FIGS. 1a and 1b) before the final step of joining the first and second sections 1S, 2S of the strip or sheet MS together.

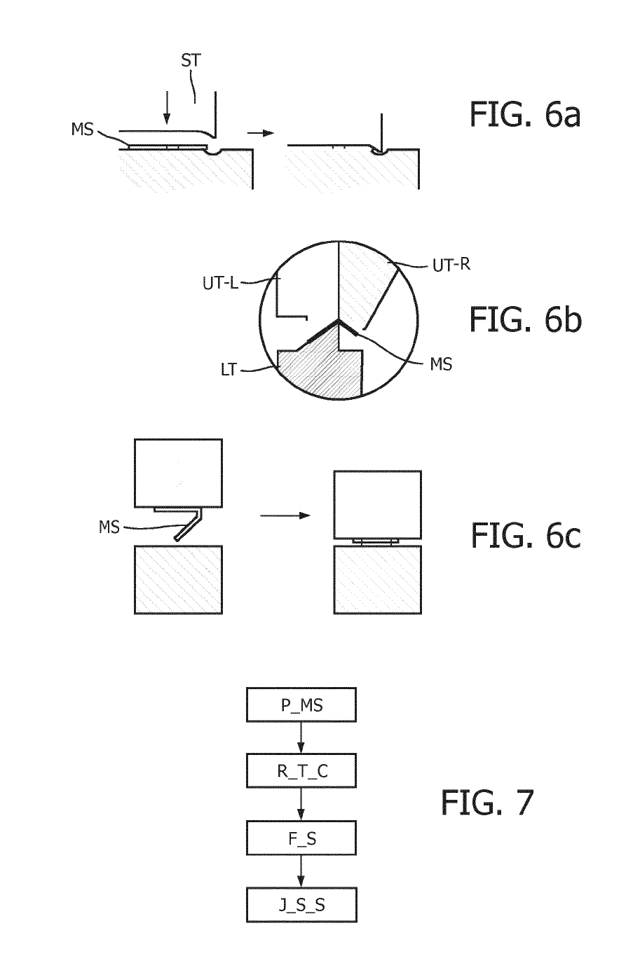

FIGS. 6a, 6b, and 6c show sketches of possible steps of a manufacturing method where the invention is applied. FIG. 6a shows the first step of pre-bending or pre-folding an end portion of the blank metal strip or sheet MS. The purpose of this first step is to enhance the further process steps. In particular, such pre-bending or pre-folding of the end portion ensures that the surfaces of the first and second sections are brought into close contact when becoming arranged adjacent to each other in the folding step. The pre-bending or pre-folding also has the effect of compensating for a spring back effect after bending and after joining. Next, FIG. 6b shows how the step of folding or bending of the pre-bent metal strip or sheet MS is performed over a lower tool part LT having a small radius by holding the metal strip or sheet MS between the lower tool part LT and the left upper tool part UT-L while moving the right upper tool part UT-R downwards. Finally, in FIG. 6c the first and second sections of the folded or at least pre-folded metal strip or sheet MS are finally pressed together so as to ensure that the first and second sections 1S, 2S of the strip or sheet remain in the completely folded state, after the process. This may be considered a joining process, however a further step of joining may include laser welding or the like.

Especially, the step of reducing the thickness or the flattening step (not specifically shown in FIGS. 6a, 6b and 6c) can be combined with the first step of pre-bending illustrated in FIG. 6a. In such an embodiment, in this first step, the shaping tool ST, i.e. the upper tool part in FIG. 6a, has a lower pressing surface having a shape resulting both in a coining process and a pre-bending process, thus providing the desired reduction of the thickness in the shaped section of the folding section FS by coining. Alternatively, the step of reducing the thickness may be performed in a separate initial process step. Thus, with such a combination, the manufacturing method according to the invention can be easily applied in existing manufacturing lines.

FIG. 7 illustrates steps of an embodiment of the manufacturing method, namely a method for manufacturing a hair-pulling element for a shaving apparatus. A first step P_MS provides a metal strip of AISI 301 stainless steel having a thickness of 80 μm or around 80 μm. Next, step R_T_C is to reduce the thickness of the strip in a predetermined folding section of the strip, wherein the folding section extends along the width of the strip. A shaping tool is preferably prepared to provide the reduction of the thickness by means of coining, such that a shaped section having a predetermined step-wise, or rectangular, reduction of the thickness to a thickness of 40-50 μm is obtained in at least a part of the folding section. Next, step F_S is to fold the strip, e.g. by performing a complete folding, or by pre-folding to a predetermined folding angle. Next, step J_S_S is to join the folded sections so that the strip remains folded, i.e. the two folded sections remain parallel or substantially parallel to each other. This may be done by applying a pressure between two plane objects, and further welding or glueing may be applied.

To sum up, the invention provides a method of manufacturing a component from a high-strength blank metal strip or sheet of a thickness. The method comprises reducing the thickness of the strip or sheet in a folding section so that a shaped section is obtained having a predetermined shape, seen in a cross-section perpendicular to the width, in at least a part of the folding section. The strip or sheet is then folded along the shaped section, so that a surface of the first section becomes arranged adjacent and parallel to a surface of the second section. Finally, the first and second sections are joined, so that the strip or sheet remains folded. With this method, it is possible to use high-strength steel, e.g. AISI 301 stainless steel, and to fold a thin strip or sheet without undesired cracks in the folding section. For example, the invention is applicable for manufacturing of blade-shaped hair-pulling elements for a shaving apparatus.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Method of manufacturing a component from a high-strength blank metal strip or sheet having a tensile strength of at least 850 MPa, the method comprising:
providing the blank metal strip or sheet having a thickness, a longitudinal extension and a width perpendicular thereto, the strip or sheet comprising a first section and a second section separated by a folding section which extends along the width of the strip or sheet,
folding the strip or sheet along the folding section with a bending radius equal to or smaller than the thickness so that a surface of the first section becomes arranged adjacent and parallel to a surface of the second sections, and
joining the first and second sections so that the strip or sheet remains folded,
wherein the method further comprises, before said folding of the strip or sheet, reducing the thickness of the strip or sheet in the folding section by use of a shaping tool so that a shaped section is obtained having a predetermined shape, seen in a cross-section perpendicular to the width, in at least a part of the folding section, and in that said folding of the strip or sheet is along said shaped section.

2. Method according to claim 1, wherein the step of reducing the thickness results in a step-wise reduction of the thickness between the shaped section and both the first section and the second section, seen in said cross-section.

3. Method according to claim 2, wherein the step of reducing the thickness results in a rectangular reduction of the thickness of the shaped section, seen in said cross-section.

4. Method according to claim 1, wherein the step of reducing the thickness results in a curved reduction of the thickness of the shaped section, seen in said cross-section.

5. Method according to claim 1, wherein a ratio between a minimum thickness of the shaped section and a thickness of the blank strip or sheet is between 0.1 and 0.95, such as between 0.1 and 0.6 or between 0.4 and 0.95, preferably between 0.5 and 0.7.

6. Method according to claim 4, wherein a radius of curvature of the curved reduction of the thickness of the shaped section is between 0.05 mm and 1.0 mm.

7. Method according to claim 1, wherein the thickness of the blank strip or sheet is from 50 μm to 2 mm, such as from 50 μm to 100 μm or from 100 μm to 500 μm or from 200 μm to 1 mm, preferably from 70 μm to 90 μm.

8. Method according to claim 1, wherein the step of reducing the thickness is performed by coining.

9. Method according to claim 1, wherein the step of reducing the thickness is performed by machining, such as by milling or grinding.

10. Method according to claim 1, wherein the metal strip or sheet is made from a material selected from: cold rolled austenitic stainless steel, hardened martensitic stainless steel, cold rolled duplex stainless steel, precipitation hardened stainless steel, hardened carbon steel, maraging steel, and a copper or nickel-based alloy spring material.

11. Method according to claim 1, wherein the component is a blade-shaped hair-pulling element for a cutting unit of a shaving apparatus.

12. An internal cutting member for a cutting unit of a shaving apparatus, said internal cutting member having cutter elements which are each provided with a cutting edge, at least one of the cutter elements being provided with an associated blade-shaped hair-pulling element which is in a frontmost position, as seen in a driven direction of the internal cutting member, and which is movable relative to the associated cutter element from and towards the cutting edge of the associated cutter element, while the blade-shaped hair-pulling element is provided with a thickened end with an edge, wherein said thickened end is manufactured by means of the steps of reducing the thickness and the steps of folding and joining the first and second sections of the metal strip or sheet according to a method according to claim 1.

13. A cutting unit for a shaving apparatus comprising a blade-shaped hair-pulling element manufactured according to a method according to claim 1, which cutting unit is provided with an external cutting member and an internal cutting member which can be driven with respect to the external cutting member, said internal cutting member having cutter elements which are each provided with a cutting edge, while said external cutting member is provided with a wall portion with hair-trapping openings which are each bounded by a counter cutting edge for cooperation with the cutting edges of the drivable internal cutting member, at least one of the cutter elements being provided with an associated blade-shaped hair-pulling element which is in a frontmost position, as seen in a driven direction of the internal cutting member, and which is movable relative to the associated cutter element during operation of the shaving apparatus from and towards the wall portion of the external cutting member, while the hair-pulling element is provided with a thickened end with an edge which, during operation of the shaving apparatus, comes into contact with a hair projecting through one of the hair-trapping openings and pulls this hair further through the hair-trapping opening before said hair is cut off by the cooperation of the cutting edge of the associated cutter element and the counter cutting edge of the hair-trapping opening, wherein the thickened end of said blade-shaped hair-pulling element is obtained by means of the steps of reducing the thickness and the steps of folding and joining the first and second sections of the metal strip or sheet.

14. A shaving apparatus provided with a cutting unit according to claim 13.
